(19) United States
(12) Patent Application Publication
(10) Pub. No.: US 2008/0118031 A1
(43) Pub. Date: May 22, 2008

(54) Metallic alloy for X-ray target

(75) Inventors: Leah F. Haywiser, Arlington, MA (US); Leonid Natan Shekhter, Ashland, MA (US)

Correspondence Address: CONNOLLY BOVE LODGE & HUTZ, LLP, P O BOX 2207, WILMINGTON, DE, 19899, US

(73) Assignee: H.C. Starck Inc.

(21) Appl. No.: 11/601,154

(22) Filed: Nov. 17, 2006

(51) Int. Cl. H01J 35/08; C22C 27/04

(52) U.S. Cl. 378/143; 420/429

(57) ABSTRACT

The present invention is directed a molybdenum alloy consisting essentially of a) molybdenum present in a major amount, b) tantalum and tungsten as major metal alloy additions and c) a minor amount of an element selected from the group consisting of boron, hafnium, carbon and mixtures thereof. The invention is also directed to an X-ray tube anode composed of a molybdenum alloy body having a focal track thereon, with the body consisting essentially of the above-described molybdenum alloy.

### BACKGROUND OF THE INVENTION

X-ray tubes used for diagnostic imaging typically consist of four main components: the anode, the cathode, the frame structure and the housing. The main function of the anode is to provide a track material for the electron beam, which is generally a tungsten-rhenium alloy. In general, the process of X-radiation production is only 1% efficient at generating characteristic X-ray radiation, the rest is converted to heat. Heat management is paramount; particularly since higher power levels are desired due to the increase in X-ray efficiency with power, and faster imaging. Due to the large energy adsorption, it is necessary to rotate the anode to constantly bring cooler material under the electron beam. Therefore, important design characteristics are the total amount of energy that can be stored in the substrate, and the ability of the anode assembly to dissipate energy. The current molybdenum construction allows energy to transfer from the focal track throughout the bulk of the target. The rim temperature of some tube units can reach 1495° C. The tungsten-rhenium focal track can approach near melting temperature (circa 3000° C.). Any volatile species, such as oxides or metals, at this temperature would be detrimental to the life of the unit.

Due to the high rotating speed, the stresses in the anode body could reach significant levels; as such the ability of the anode to bear both physical and thermal loads is critical. The anode has to be mechanically strong. One technique to strengthen metals is alloying with impurity atoms that go into either substitutional or interstitial solid solution, called “solid-solution hardening”. High-purity metals are almost always softer and weaker than alloys composed of the same base metal. Increasing the concentration of the alloying elements results in a corresponding increase in tensile strength and hardness.

Alloys are stronger than pure metals because alloy atoms that go into solid solution ordinarily impose lattice strains on the surrounding host atoms. Lattice strain field interactions between dislocations and these alloying atoms result, and, consequently, dislocation movement is restricted. For example an alloying atom that is smaller than a host atom for which it substitutes exerts tensile strains on the surrounding crystal lattice. Conversely a larger substitutional atom imposes compressive strains in its vicinity. These solute atoms tend to segregate around dislocations in a way so as to reduce the overall strain energy, that is, to cancel some of the strain in the lattice surrounding a dislocation. The resistance to slip is greater when alloying atoms are present because the overall lattice strain must increase if a dislocation is torn away from them.

Several different materials have been described as being useful as x-ray tube anodes. See, for example, U.S. Pat. No. 3,660,053 (an alloy of tungsten and platinum); U.S. Pat. No. 4,000,434 (consisting of i) a support body of a tungsten-molybdenum alloy, ii) a first layer of tungsten or tungsten alloy on one side of the support and iii) a second layer of an alloy of tungsten with niobium, tantalum, zirconium, hafnium, rhenium, ruthenium, or mixtures thereof on the other side of the support); U.S. Pat. No. 4,195,247 (a molybdenum body alloyed with a stabilizing proportion of iron, silicon, cobalt, tantalum, niobium, hafnium, stable metal oxides or mixtures thereof—see also U.S. Pat. No. 4,298,816); U.S. Pat. No. 4,461,020 (a multilayer device that includes the use of molybdenum-tungsten alloys); 4,534,993 (alloys of molybdenum, titanium, zirconium and carbon and alloys of molybdenum and tungsten); U.S. Pat. No. 4,780,902 (an alloy of molybdenum, hafnium, zirconium and carbon); U.S. Pat. No. 5,138,645 (a tungsten alloy or molybdenum alloy with tantalum); U.S. Pat. No. 5,159,619 (includes a molybdenum or niobium layer containing titanium, hafnium, zirconium, tungsten and/or tantalum); U.S. Pat. No. 5,222,116 (molybdenum in a major amount and tantalum, hafnium, zirconium and carbon ion minor amounts); and U.S. Pat. No. 6,428,904 (a target substrate of TZM molybdenum and a focal track of a tungsten-rhenium alloy—see also U.S. Pat. No. 6,132,812).

Finally U.S. Pat. No. 4,165,982 describes a molybdenum alloy containing i) zirconium and/or hafnium, ii) carbon, iii) oxygen and iv) nitrogen.

### DESCRIPTION OF THE INVENTION

This invention relates to a metallic alloy and to X-ray tube anode targets made therefrom. More particularly, the present invention is directed to a molybdenum alloy consisting essentially of a) molybdenum present in a major amount, b) tantalum and tungsten as major metal alloy additions and c) a minor amount of an element selected from the group consisting of boron, hafnium, carbon and mixtures thereof. As used herein, the phrase “major amount” means an amount of at least 90% by weight. As used herein, the phrase “major metal alloy additions” means an amount of greater than 1% and no more than 10% by weight and the phrase “minor amount” means an amount of greater than 0 and no more than 0.3%.

In a preferred embodiment, a) the molybdenum is present in an amount of from about 91 to about 98% by weight, b) the tantalum is present in an amount of from about 0.5 to about 5% by weight and the tungsten is present in an amount of from about 0.5 to about 5% by weight, and c) the boron is present in an amount of from 0 to 0.09% by weight, the hafnium is present in an amount of from 0 to 0.09% by weight and the carbon is present in an amount of from 0 to 0.09% by weight, with the proviso that
i) component b) is present in an amount of 1.73% by weight to 8.995% by weight and
ii) component c) is present in an amount of from about 0.005 to 0.27% by weight.

The invention is also directed to an X-ray tube anode composed of a molybdenum alloy body having a focal track thereon, with the body consisting essentially of molybdenum alloy consisting essentially of a) molybdenum present in a major amount, b) tantalum and tungsten as major metal alloy additions and c) a minor amount of an element selected from the group consisting of boron, hafnium, carbon and mixtures thereof. As is known in the art, the focal track is typically a tungsten-based alloy.

X-ray tube anode targets and methods of production thereof are known in the art and are described in U.S. Pat. Nos. 3,660,053, 4,000,434, 4,195,247, 4,298,816, 4,461,020, 4,534,993, 4,780,902, 5,138,645, 5,159,619, 5,222,116, 6,132,812 and 6,428,904, all the disclosures of which are hereby incorporated by reference.

The alloys of the present invention are characterized by a) the ability to store a large amount of energy, b) the ability to transport large amounts of energy, and c) the ability to withstand deformation during rotation under a heat load.

It will be appreciated that the invention is not limited to the specific details set forth and that various modifications may be made without departing from the spirit and scope of the invention.

What is claimed is:

1. A molybdenum alloy consisting essentially of a) molybdenum present in a major amount, b) tantalum and tungsten as major metal alloy additions and c) a minor amount of an element selected from the group consisting of boron, hafnium, carbon and mixtures thereof.

2. The molybdenum alloy of claim 1, wherein a) said molybdenum is present in an amount of from about 91 to about 98% by weight, b) said tantalum is present in an amount of from about 0.5 to about 5% by weight and said tungsten is present in an amount of from about 0.5 to about 5% by weight, and c) said boron is present in an amount of from 0 to 0.09% by weight, said hafnium is present in an amount of from 0 to 0.09% by weight, said carbon is present in an amount of from 0 to 0.09% by weight, with the proviso that
i) said component b) is present in an amount of 1.73% by weight to 8.995% by weight and
ii) component c) is present in an amount of from about 0.005 to 0.27% by weight.

3. An X-ray tube anode composed of a molybdenum alloy body having a focal track thereon, said body consisting essentially of the alloy of claim 1.

4. An X-ray tube anode composed of a molybdenum alloy body having a focal track thereon, said body consisting essentially of the alloy of claim 2.
